(19) United States
(12) Patent Application Publication
(10) Pub. No.: US 2025/0014120 A1
(43) Pub. Date: Jan. 9, 2025

(54) SYSTEMS AND METHODS FOR A PROFESSIONAL NETWORKING PLATFORM

(71) Applicant: HYLX Inc., Dover, DE (US)

(72) Inventor: James R Beckley, San Marcos, CA (US)

(21) Appl. No.: 18/219,110

(22) Filed: Jul. 7, 2023

(51) Int. Cl. G06Q 50/00; G06F 3/0482; H04L 51/046; H04L 51/52

(52) U.S. Cl. CPC G06Q 50/01; G06F 3/0482; H04L 51/046; H04L 51/52

(57) ABSTRACT

A system for professional networking includes at least one processor, at least one computer readable storage medium, a plurality of connection types including a mutual connection, a saved connection, and a linked connection, program code executable on the at least one processor and stored on the at least one computer readable storage medium, for: determining a selected connection type from the plurality of connection types is assigned to a pair of users in the system for professional networking; and determining one or more functionalities provided to the pair of users. The determining is based, at least in part, on the selected connection type. A link is created when a first user requests to link and a second user agrees to the request to be linked, and the link between the first user and the second user enables an advanced communication feature.

### TECHNICAL FIELD

The present invention is directed to systems and methods for improved professional networking. More specifically, systems and methods for a relationship driven platform that empowers entrepreneurs and brands to build and expand their reach.

### BACKGROUND INFORMATION

The field of professional networking has grown rapidly; however, current solutions fail to effectively address the needs of our evolving modern-day workforce. Today's entrepreneur and professional typically operates at least one or more businesses or has multiple professional engagements and maintains several resumes and portfolios for different purposes, thereby representing a genuine necessity for a networking technology that is versatile, customizable, and adaptable to any situation. New younger users require improved and streamlined functionalities to efficiently grow their network and their business.

### SUMMARY

In a first novel aspect, a system for professional networking includes at least one processor, at least one computer readable storage medium, a plurality of connection types including a mutual connection, a saved connection, and a linked connection, program code executable on the at least one processor and stored on the at least one computer readable storage medium, for: determining a selected connection type from the plurality of connection types is assigned to a pair of users in the system for professional networking; and determining one or more functionalities provided to the pair of users, wherein the determining is based, at least in part, on the selected connection type.

In a second novel aspect, a link is created when a first user requests to link and a second user agree to the request to be linked, and the link between the first user and the second user enables an advanced communication feature.

In a third novel aspect, the advanced communication feature is a direct messaging capability, a create group channel capability, an invite other users to group channel capability, or communicate an opportunity request.

In a fourth novel aspect, the group channel is a multi-user chat group.

In a fifth novel aspect, the advanced communication feature is not enabled for the saved connection.

In a sixth novel aspect, the advanced communication feature is not enabled for the mutual connection.

In a seventh novel aspect, a mutual connection is created when a first user and a second user are both connected to a third user, and the first user and the second user are not connected.

In an eighth novel aspect, a saved connection is created when one of the following occurs: when a contact information is entered into a first user's public facing webpage; or when a first user shares a second user's contact information with a third user, wherein the second user and the third user are not connected.

In a ninth novel aspect, the system is configured to display a user interface, and the user interface includes a tile of a network connection, and wherein the tile includes a visual indicator as to the connection type of the network connection.

In a tenth novel aspect, the tile of a network connection includes a request to link button that when selected causes a request to link with a user identified in the tile to be generated.

In an eleventh novel aspect, the first user's public facing webpage is provided by the system for professional networking.

In a twelfth novel aspect, the system includes program code executable on the at least one processor and stored on the at least one computer readable storage medium, for: storing and displaying personalized notes for each user.

In a thirteenth novel aspect, a method includes (a) storing a first user's contact information; (b) storing a second user's contact information; (c) determining a connection type between the first user and the second user; (d) enabling one of a plurality of communication functionalities between the first user and the second user, wherein the enabling of (d) is based on the connection type between the first user and the second user; and (e) providing a means to allow either the first user or the second user to change the enabled plurality of communication functionalities between the first user and the second user.

### BRIEF DESCRIPTION OF THE DRAWINGS

The accompanying drawings, where like numerals indicate like components, illustrate embodiments of the invention.

FIG. 1 is an illustration of various user interfaces within the professional networking system.

FIG. 2 is a diagram illustrating mutual connections within the professional networking system.

FIG. 3 is a diagram illustrating saved connections within the professional networking system.

FIG. 4 is a diagram illustrating linked connections within the professional networking system.

FIG. 5 is a diagram illustrating connection view options within the professional networking system.

FIG. 6 is a diagram of a group channel multi participant chat within the professional networking system.

FIG. 7 is a diagram illustrating the connection search capability within the professional networking system.

FIG. 8 is a diagram illustrating user connection controls within the professional networking system.

FIG. 9 is a diagram illustrating connection data organization within the professional networking system.

FIG. 10 is a diagram illustrating user circles within the professional networking system.

FIG. 11 is a diagram illustrating user community groups within the professional networking system.

FIG. 12 is a flowchart diagram reciting the filtering operation performed by the professional networking system.

FIG. 13 is a flowchart diagram reciting the searching operation performed by the professional networking system.

FIG. 14 is a flowchart diagram reciting the sorting operation performed by the professional networking system.

FIG. 15 is a flowchart diagram reciting the geographical proximity connection operation performed by the professional networking system.

FIG. 16 is a flowchart diagram reciting the user verification operation performed by the professional networking system.

FIG. 17 a flowchart diagram reciting the steps of determining one or more functionalities provided to a pair of users within the professional networking system.

FIG. 18 is a flowchart diagram reciting the steps for determining a connection type between a first and second user within the professional networking system.

FIG. 19 is a flowchart diagram for setting the steps for determining a type of clickable link to be displayed for each user within the professional networking system.

### DETAILED DESCRIPTION

Reference will now be made in detail to background examples and some embodiments of the invention, examples of which are illustrated in the accompanying drawings. In the description and claims below, relational terms such as “top”, “down”, “upper”, “lower”, “top”, “bottom”, “left” and “right” may be used to describe relative orientations between different parts of a structure being described, and it is to be understood that the overall structure being described can actually be oriented in any way in three-dimensional space.

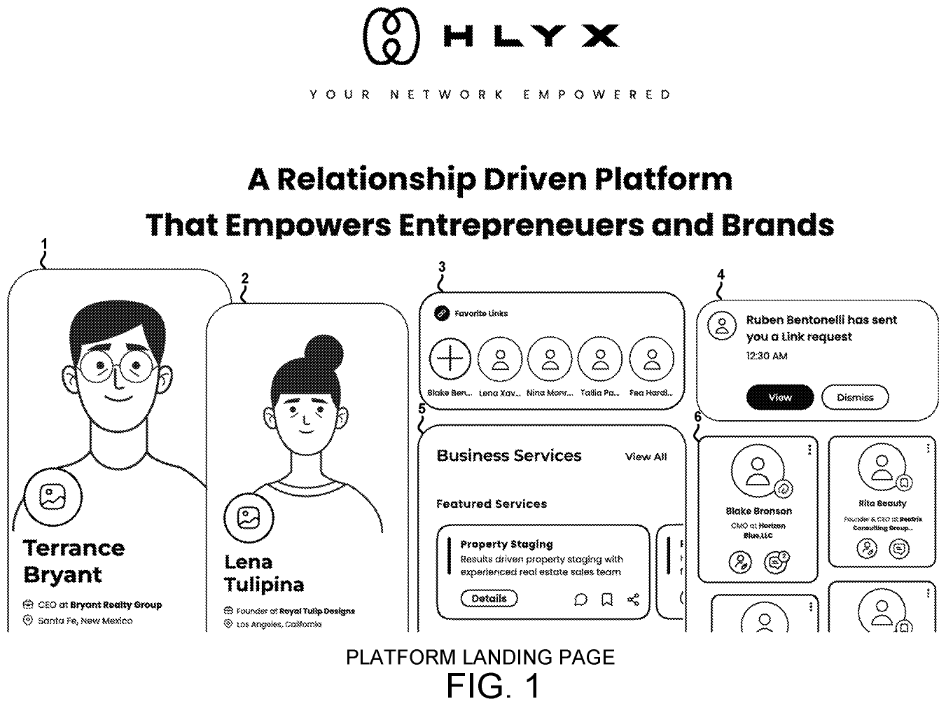

FIG. 1 is an illustration of various user interfaces within the professional networking system. For example, user interface 1 includes a photo of user Terrence Bryant, lists his name, displays his logo, lists his title and company name (CEO at Bryant Realty group), and lists his location (Santa Fe, New Mexico). Each user is able to upload a business logo or image representing their brand. User interface 2 includes a photo of user Lena Tulipina, list her name, displays her logo, lists her title and company name (founder at royal Tulip designs), and lists her location (Los Angeles, California). User interface 3 includes an array of favorite links including images for each favorite link and a button to add a new favorite link. User interface 4 illustrates a notification that a link request has been sent. User interface 4 also includes an image of the person relevant to the notification, The time of the notification and two action buttons. The first action button is to view the notification details. The second action button is to dismiss the notification. User interface 5 lists business services. Business services may include featured services that are relative to the users business operations. For example, user Terence Bryant who runs Bryant Realty group may have an interest in property staging, therefore user interface 5 listing business services will illustrate a featured service of property staging. The listing of property staging will also include a description of the featured service (results driven property staging with experienced real estate sales team). The featured services listing will include an action button to view more details, a comment button that when pressed creates a communication thread where user 1 can request more information from user 2 or initiate a deal flow process to engage in business with user 2, a bookmark button to save the featured service to a favorites list, and a share button to share the featured service with another person within the professional networking system. User interface 6 list contact information saved within the professional networking system. User interface 6 also includes a link to message with the contact listed in user interface 6 or to edit the tags and notes information of the contact listed in user interface 6.

In the system for professional networking a user cannot edit another users contact information. Profiles are independently created and managed by individual or company account owners. Therefore, only profile owners can edit their contact information. The ‘Contact Details’ page only displays information relative to both user 1 and user 2 based on their connection type and interaction history. The only data that can be edited in ‘Contact Details’ are notes, tags, and location. If the system for professional networking receives incorrect location data during the initial in-person meeting of both user 1 and user 2, both user 1 and user 2 may modify the meeting location record in their respective ‘Contact Details’ page of the other user.

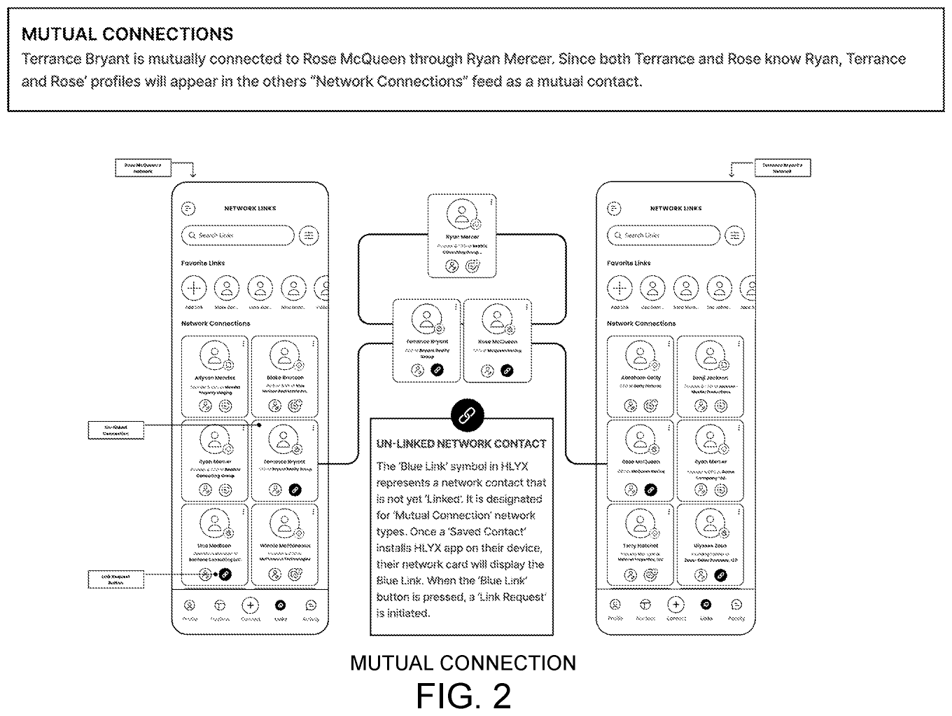

FIG. 2 is a diagram illustrating mutual connections within the professional networking system. Terrence Bryant is mutually connected to Rose McQueen through Brian Mercer. Since both Terrence and Rose are connected to Ryan, the profiles of Terrence and Rose will appear in each other's network connections feed as a mutual contact.

On the left of the diagram is a user interface listing Rose McQueen's network of connections. Rose McQueen's network of connections includes both linked and un-linked connections. One example of a linked connection in Rose McQueen's network is Blake Bronson. Accordingly, the tile illustrating the information regarding the Blake Bronson contact has two action buttons: an edit contact details button and a send a message button. It is noted herein that contact information can only be edited by the contact owner. Alternatively, an example of an un-linked connection in Rose McQueen's network is Terrence Bryant. The tile illustrating the information regarding Terrence Bryant does not include an action button to send a message, but rather includes a link request button. When selected, the link request button sends a request on behalf of Rose McQueen to Terrence Bryant, requesting to become network linked contacts.

On the right side of the diagram is a user interface listing Terrence Bryant's network of connections. Terrence Bryant's network of connections includes both linked and un-linked connections. One example of a linked connection in Terrence Bryant's network is Abraham Getty. Accordingly, the tile illustrating the information regarding the Abraham Getty contact has two action buttons: an edit contact details button and a send a message button. Alternatively, an example of an un-linked connection in Terrence Bryant's network is Rose McQueen. The tile illustrating the information regarding the Rose McQueen contact does not include an action button to send a message, but rather includes a link request button. When selected the link request button sends a request on behalf of Terrence Bryant to Rose McQueen, requesting to become network link contacts.

The link symbol represents a network contact that is not yet linked. It is designated for mutual connection network types. Once a saved contact is uploaded to the system the contact will be display on the user interface and will include the request to link button. When the request to link button is selected, a link request is initiated.

A link connection provides advanced communication features between the two linked users. Advanced communication features include direct messaging, ability to create a group channel, ability to invite other users to group channel, and ability to send opportunities requests. An opportunity request is a deal flow communication and management feature that initiates business and/or exchange of information between one or more users by creating a dedicated communication and activity thread that is tied to a specific subject. An opportunity requests is illustrated in screen 5 of FIG. 1. Only the specific subject can be discussed as the system is designed to only facilitate communication and opportunities that are associated with the subject. Examples of subjects include service or product offerings, portfolio items, business needs, and business goals. Each opportunity request initiates interaction with a user that is specific to only their advertised subject. Subjects can only be viewed or engaged with through a user's profile card. The following actions are initiated by an opportunity request: a request to engage in business associated to a service/product/portfolio/business need/business goal featured in a user's profile card, a request for information specific to a service/product/portfolio/business need/business goal featured in a user's profile card, or a sharing of a dedicated link to a service/product/portfolio/business need/business goal featured in a user's profile card. The message, bookmark, and share grouped icons that are seen across the different pages of the system are the mechanisms that activate an opportunity request. This feature is automated in that the user can press one button, select from a list of options and then the system automatically sends an opportunity request to a user, thereby initiating a dedicated thread for just the specific subject.

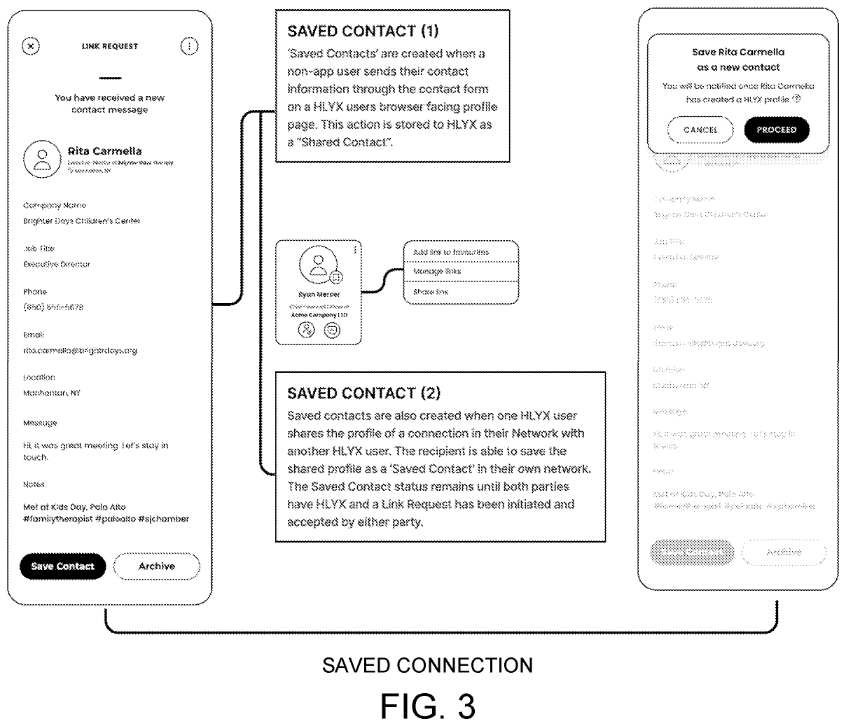

FIG. 3 is a diagram illustrating saved connections within the professional networking system.

A saved contact is created when a non-registered user submits their contact information through the public facing card contact form via a registered user's website profile card provided by the system for professional networking. The contact information is then stored in the recipient's ‘Activity’ feed until the recipient has had an opportunity to review the shared information. The recipient/registered user has to then select the ‘Save Contact’ button before the contact information shared is saved to the user's network. This acts as a filter since anyone who has access to the registered user's public facing profile card can submit contact information. In another embodiment, advanced safeguards validate and filter the contact information data before submission is allowed and any contact information data not aligned with the platforms ‘validation model’ will be discarded.

The user interface on the left of the diagram illustrates a link request. The link request indicates that you've received a new contact message, the name of the person requesting to link, the details regarding the person requesting to link, a message from the person requesting the link, notes regarding how you and the contacts met or are connected, a save contact button, and an archive button. The details regarding the person requesting the link may include company name, job title, phone number, e-mail, and location.

The user interface on the right of the diagram illustrates a notification displayed when the save contact button is selected. The notification indicates That the contact was saved as a new contact and includes a notice that the user will be notified when the requesting user registers with the system. The notification also includes a cancel button and a proceed button. When selected, the cancel button stops the new contact addition. When selected, the proceed button finalizes the addition of the contact to the user's saved contact list.

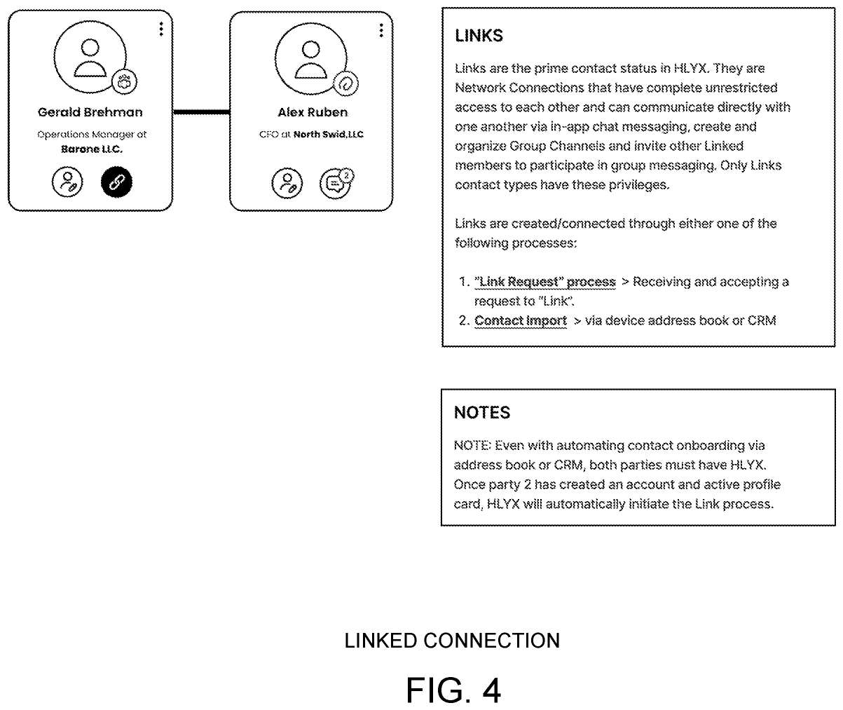

FIG. 4 is a diagram illustrating linked connections within the professional networking system. Linked connections are the highest level of connection available in the professional networking system. Linked connections have complete unrestricted access to each other and can communicate directly with one another via in-system chat messaging, can create and organize group channels, and can invite other linked members to participate in Group messaging. Un-linked contacts do not have these abilities. A linked connection can be created when both users agree to be linked.

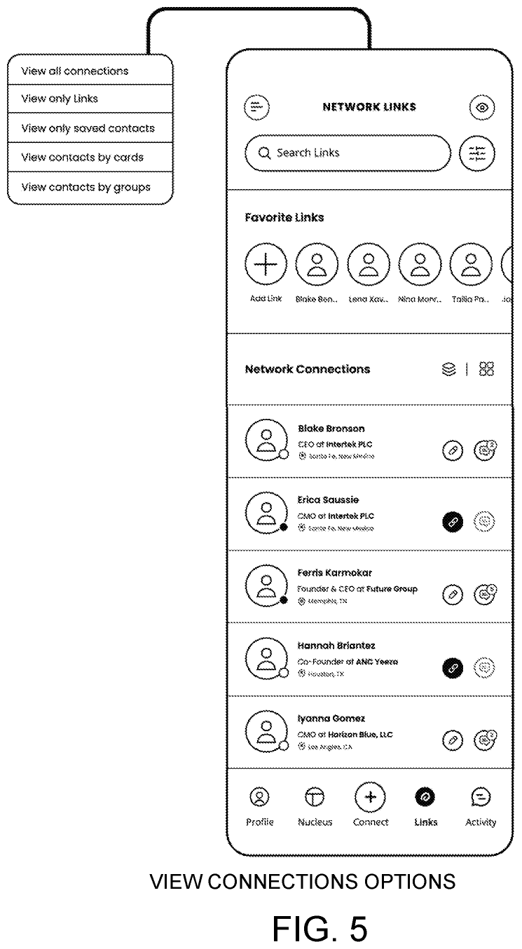

FIG. 5 is a diagram illustrating connection view options within the professional networking system. The professional networking system provides multiple connection view options. The connection view options include view all connections, view only links, view only saved contacts, view contacts by cards, and view contacts by groups. Selection of the desired connection view can be performed by selecting an icon next to the network connection title. Once the icon is selected, a pop up menu listing all of the various connection view options is displayed. The user may then select one of the listed view options and in response the network connections listed on the user interface will update to the selected connection view option.

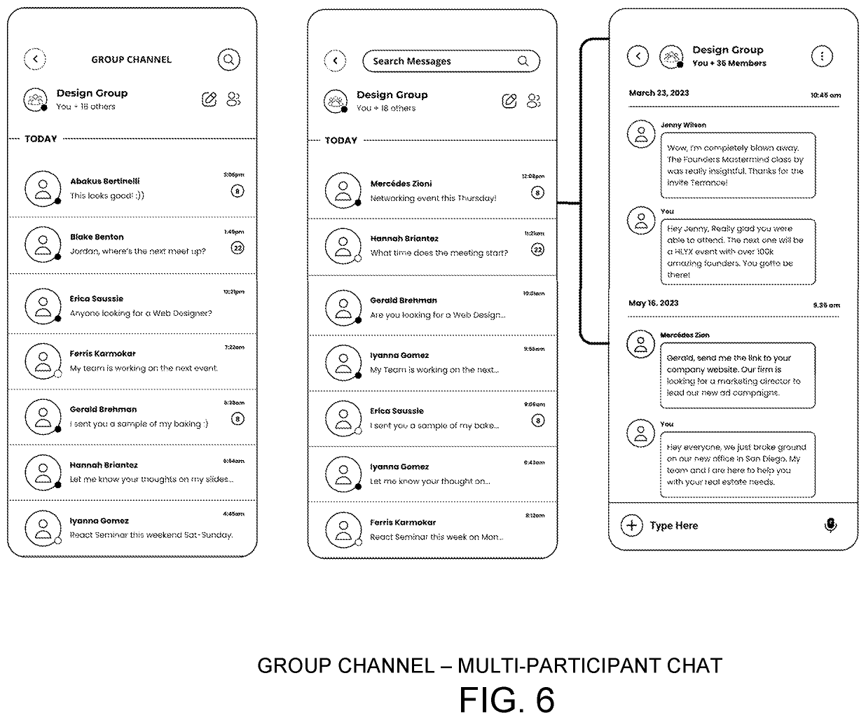

FIG. 6 is a diagram of a group channel multi-participant chat within the professional networking system. A group channel may be created by any registered user. The registered user after creating the group channel may invite any of the users linked contacts to join the group channel. Once the users are in the group channel, the participating users may send messages to everybody else in the group channel. Each message sent to the group can be responded to, thereby creating a new thread of comments relevant to the first general group message. This is illustrated in FIG. 6. The user interface on the left of the diagram is for a group channel named “Design Group”. The group includes 18 members which is indicated underneath the “Design Group” title. Beneath the title there is a listing of all group messages. In the middle of the diagram there is a user interface illustrating the “Design Group” group channel including a plurality of group messages, wherein one of the group messages has multiple responses generating a new comment thread regarding that single group message. The comment thread is illustrated in the user interface on the right side of the diagram. The comment thread includes an identifier of each user that posted each comment on the thread. The comment thread also includes the date and time of each comment posted on the thread. The comment thread also includes a text field where new comments can be added by a registered user that is part of the group channel.

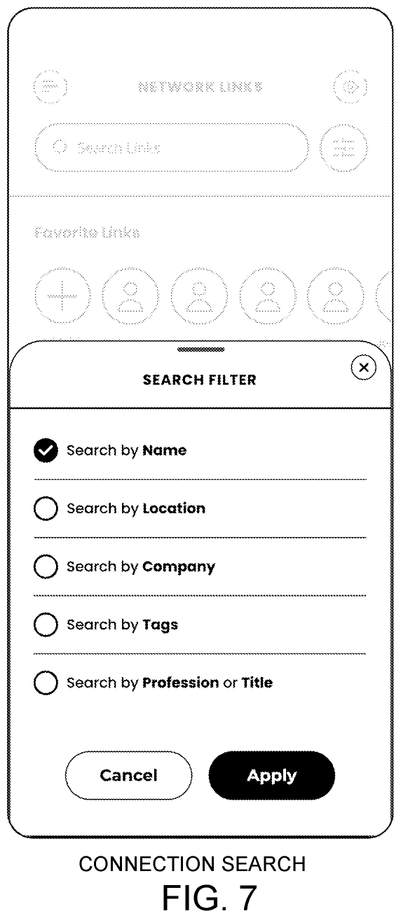

FIG. 7 is a diagram illustrating the connection search capability within the professional networking system. Each user in the professional networking system can search their connections via multiple attributes. For example, a user in the professional networking system can search their own connections by name, location, company, tags, profession, or title. Once the user has selected the desired search methodology, the user can select the apply button and the search results are displayed to the user on the user interface.

A tag may include a single word or a string of three consecutive words. In one example, each tag must be separated by a comma.

Tags are associative words that help a user more effectively remember details of their association and connection to another user. For example, the following: “Palo Alto, City Hall Gala, Dentist, works downtown PA, needs office space”, are associative words chosen by user 1 to help classify the location, event, profession, and specific need of a new connection that was made.

A network contact can add one or more tags to the Contact Details page of any user they are networked with as a link or a mutual connection. Tags are a useful and convenient way to classify a network contact because they are easily searchable. Once added to the Contact Details page, each tag becomes associated to the specific contact, and can be searched by applying a the ‘Tag’ filter in the search bar.

Tags can also be created by non-registered users through the public facing website contact form of a registered user's profile card. There is a ‘Tag’ field on the contact form. If the person completing the form adds tags, that information will be included in the Saved Contact message sent to the profile card owner. Thus, when a Saved Contact creates an account with the professional networking platform, their ‘Contact Details’ page will automatically contain the tags they originally added to the Contact Form.

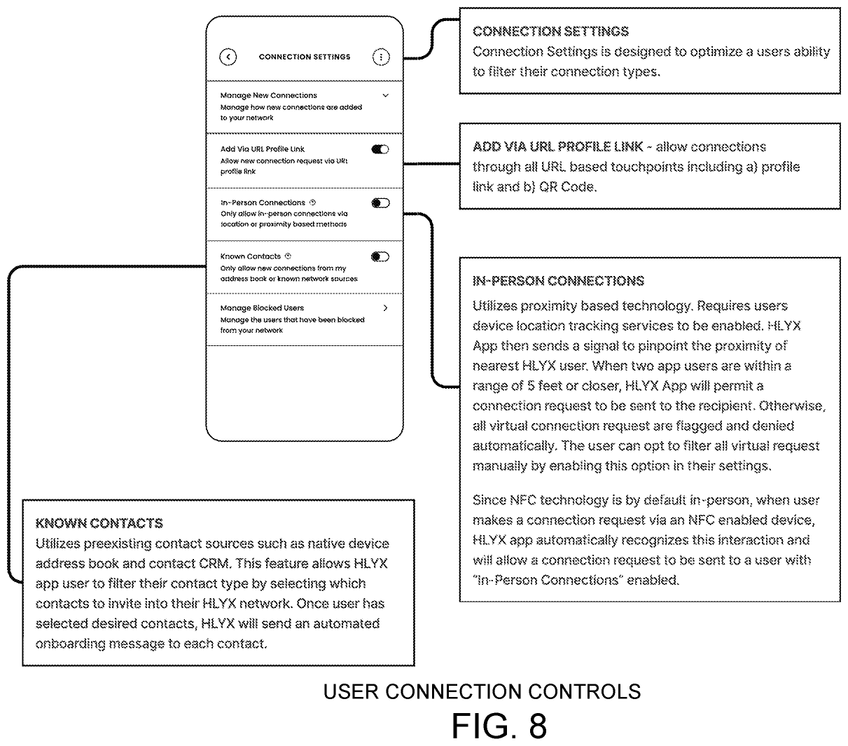

FIG. 8 is a diagram illustrating user connection controls within the professional networking system. Each user is provided various connection settings to optimize the usability of the professional networking system.

One example of an adjustable connection setting is the ability to connect with another user via a URL profile link. This option allows the addition of new connections through profile link or QR code. Each user can enable or disable this functionality via the connection settings menu. The ‘allow new connections via URL’, is a feature that enables or disables the ability for new connections to be initiated through the public facing profile card. When this option is disabled, the contact form on the public facing profile card is disabled, thereby forcing new connections only through the system for professional networking after becoming a registered user of the system. This feature allows for greater user selectivity. Some users will prefer being able to view the profile card (and all the information it contains) of a potential new connection first. For users who are very selective and particular about who they allow in their network, this option gives them more information to work with when making a determination on a prospective new connection requesting to join their network.

Another example of an adjustable connection setting is to only allow in-person connections via location or proximity based methods. When this connection setting is enabled proximity and or geolocation technology is used. This setting requires the user device location tracking services to be enabled. The system is able to send a signal to pinpoint the proximity of the nearest registered user. When two users are within a predetermined range, the system will allow a connection request to be sent from one user to another. Any requests made from other users outside of the predetermined range will be automatically denied or put into a request queue that the user can manually review. Various technologies can be used to determine whether or not the two users are within the predetermined range. For example, near field communication technology, GPS technology, bluetooth technology, wi-fi technology, or video technology may be used to determine if the two users are within the predetermined range.

Another example of an adjustable connection setting is to only allow new connections from the user's address book or from a known network source to submit a connection request. This setting may utilize pre-existing contact sources such as a native device address book or a contact CRM database. This setting allows registered users to filter their contact type by selecting which contacts to invite into their network. Once the user has selected the desired contacts the system will send an automatic onboarding message to each of the user's contacts.

One more example of an adjustable connection setting is to allow the user to manage interactions with other users. Adjustable connection settings include: ‘Mute’ which ceases all communications and activity notifications, ‘Remove from my network’ which completes removal as a connection (deletes entire Link), ‘Block’ which removes a user from the user's Network Connections feed and revokes the blocked user's communication and Link privileges, ‘Permanently Block’ which indefinitely bans the blocked user as a network connection of the blocking user, blocks all communication, shares and requests, and ‘Unblock’ which restores the blocked user's privileges.

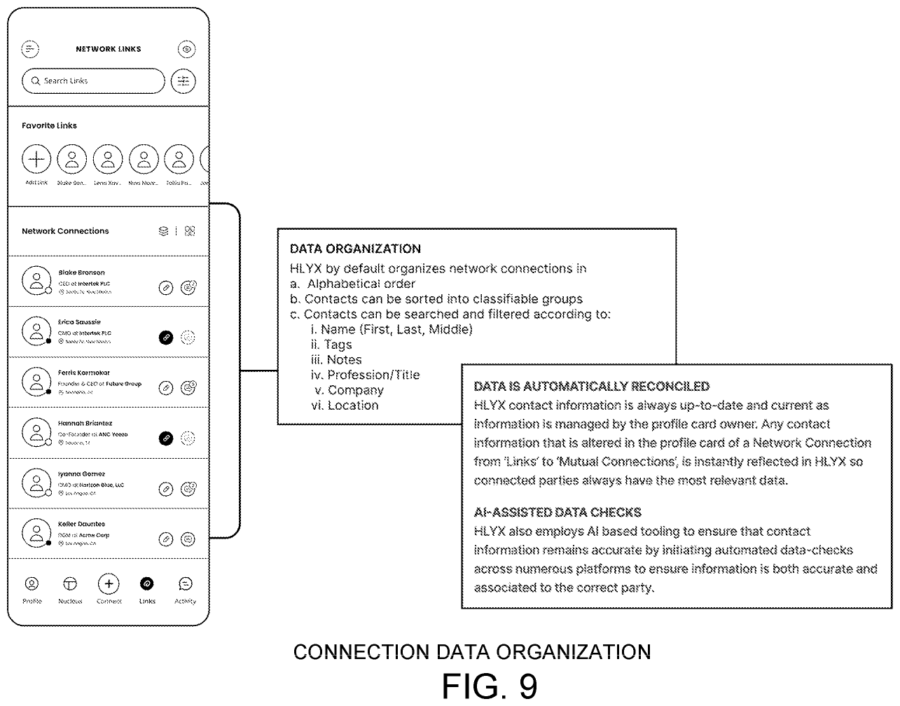

FIG. 9 is a diagram illustrating connection data organization within the professional networking system. The professional networking system automatically organizes network connections according to various attributes. For example, the professional networking system may automatically organize network connections based upon alphabetical order, name, tags, notes, user profession, title, company, or location. Contact information stored in the professional networking system is automatically updated across all users of the professional networking system when a single user contact profile is updated, such that all other users of the professional networking system always have access to updated contact information of all users.

Advanced systems such as artificial intelligence may be used to ensure that all user contact data in the professional networking system is up to date and accurate. For example, machine learning systems may gather data from outside of the professional networking system and perform a correlation with the data stored in the professional networking system to determine whether or not the user contact information is valid and up to date. This automated verification and updating of user contact information can be performed continuously, periodically, or semi-randomly depending on system performance and resource allocation.

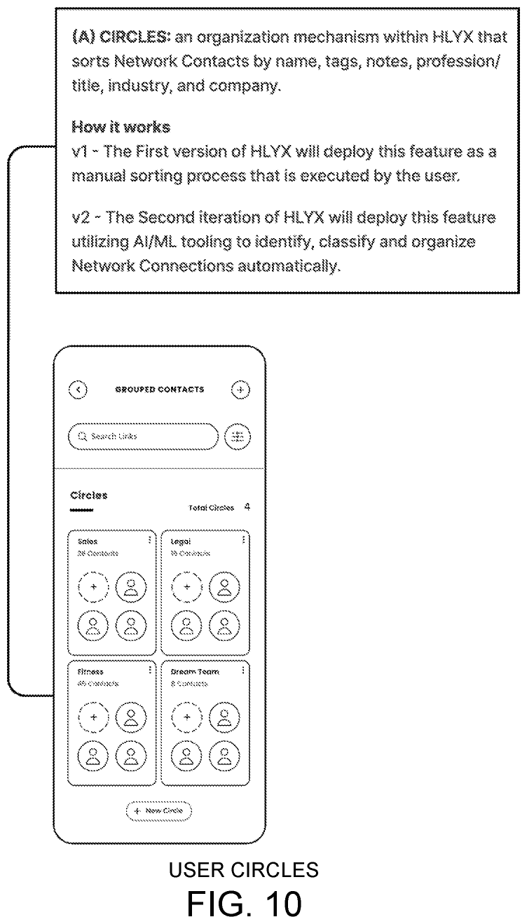

FIG. 10 is a diagram illustrating user circles within the professional networking system. A circle is an organizational mechanism within the professional networking system that sorts network contacts by name, tags, notes, profession, title, industry, and company. For example, the professional networking system may provide a manual sorting process that is executed by the user so to sort the user contacts by the various attributes listed above. In another example, the professional networking system will utilize artificial intelligence to identify, classify, and organize network connections automatically for the user based upon learning data regarding the user's behaviors, uses, and needs. In one example, the user interface may display one or more circles as tiles within the user interface. One circle tile may be titled based upon the type of contacts included in that circle's tile. For example, one circle tile may be entitled “Sales”, another circle tile may be entitled “Legal”, another circle tile may be entitled “Fitness”, and another circle tile may be entitled “Dream Team”. Within each circle tile the one or more contacts included in that circle are displayed. Within each circle tile there is also an logo that when selected allows the user to add a connection to that circle. Moreover, the user interface that displays the various circles also includes a selectable button to allow the user to create a new circle that includes a different grouping of network connections.

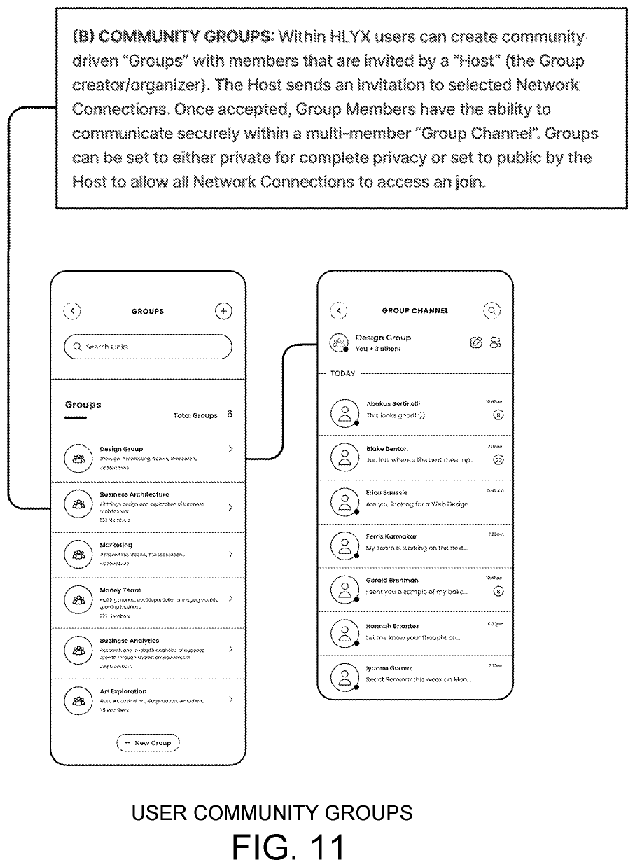

FIG. 11 is a diagram illustrating user community groups within the professional networking system. Users in the professional networking system can create community driven groups with members that are invited by a host user. The host user may send an invitation to selected network connections. Once the invitations are accepted by the network connections, the host and the network connections are part of a group and have the ability to communicate securely within the group channel. The groups have individual privacy settings. For example, each group can be set to be private so that no other users in the professional networking system can see the contents of the group. Alternatively, each group can be set to public status such that all users on the professional networking system can view the contents of the group. In one example, the privacy status of the group is determined by the host user that invited users to the group in the first place. In one embodiment, administration privileges are transferrable to another group member. In yet another embodiment administration privileges are transferrable to sub-admins/managers, co-admins, etc.

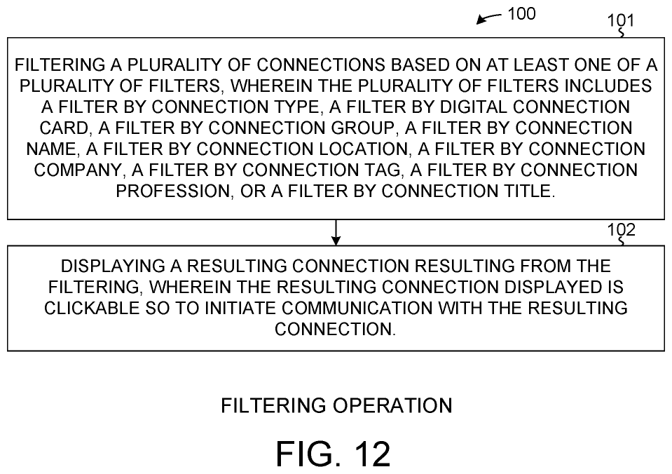

FIG. 12 is a flowchart 100 diagram reciting the filtering operation performed by the professional networking system. In step 101, a plurality of connections is filtered based on at least one of a plurality of filters. The plurality of filters include: a filter by connection type, a filter by digital connection card, a filter by connection group, a filter by connection name, a filter by connection location, a filter by connection company, a filter by connection tag, a filter by connection profession, or a filter by connection title. In step 102, a resulting connection resulting from the filtering is displayed. The resulting connection displayed is clickable so to initiate communication with the resulting connection.

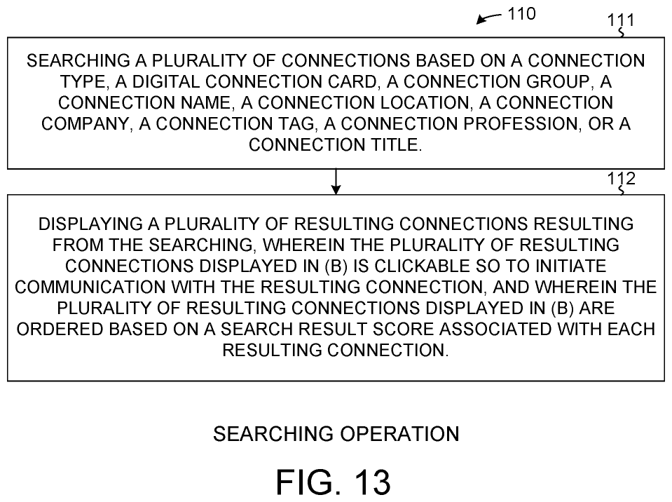

FIG. 13 is a flowchart 110 diagram reciting the searching operation performed by the professional networking system. A plurality of connections is searched based on a connection type, a digital connection card, a connection group, connection name, a connection location, a connection company, a connection tag, a connection profession, or a connection title. In step 112, a plurality of resulting connections resulting from the searching of step 111 are displayed. The plurality of resulting connection displayed is clickable so to initiate communication with the resulting connection, and the plurality of resulting connections displayed are ordered based on the search results score associated with each resulting connection. The search result score may be based on many different criteria. For example, the search result score may be based on number of letters that are similar to the search phrase, may be based on geographic location, maybe based on the connection profession, or any other useful connection attribute similarity ranking to the search phrase.

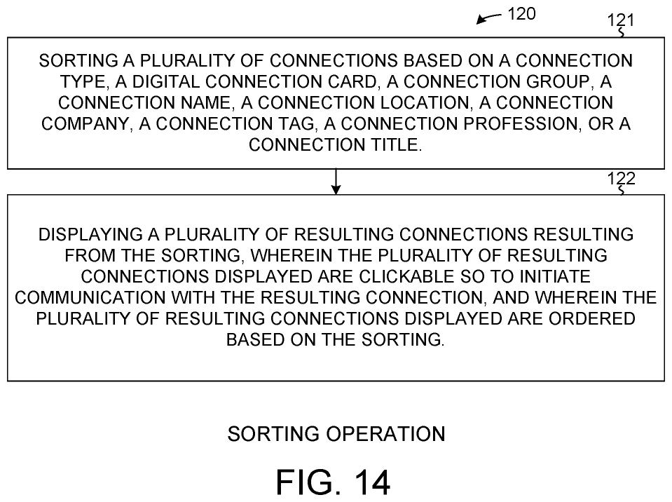

FIG. 14 is a flowchart 120 diagram reciting the sorting operation performed by the professional networking system. In step 121, a plurality of connections is sorted based on a connection type, a digital connection card, a connection group, a connection name, a connection location, a connection company, a connection tag, a connection profession, or a connection title. In step 122, a plurality of resulting connections resulting from the sorting of step 121 are displayed. The plurality of resulting connections displayed are clickable so to initiate communication with the resulting connection, and the plurality of resulting connections displayed is ordered based on the sorting performed in step 121.

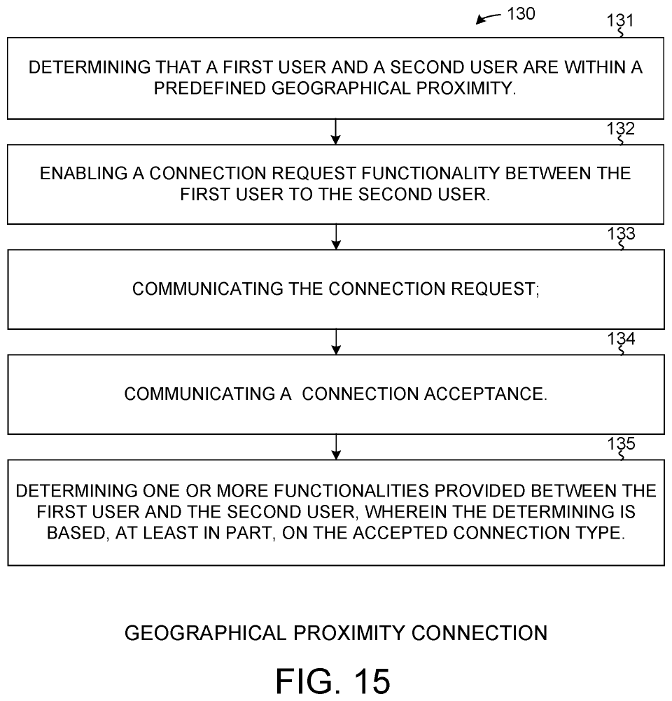

FIG. 15 is a flowchart 130 diagram reciting the geographical proximity connection operation performed by the professional networking system. In step 131, it is determined that a first user and a second user are within a predefined geographical proximity. In step 132 a connection request functionality is enabled between the first user and the second user. In step 133, a connection request is communicated. In step 134, a connection acceptance is communicated. In step 135, one or more functionalities provided between the first user and the second user are determined. The determining is based, at least in part, on the accepted connection type.

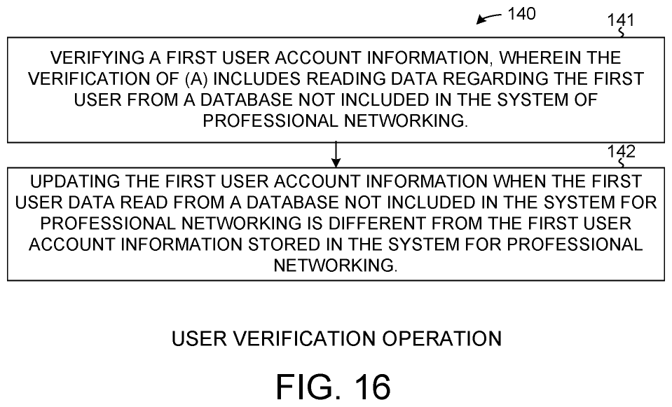

FIG. 16 is a flowchart 140 diagram reciting the user verification operation performed by the professional networking system. In step 141, a first user account information is verified. The verification includes reading data regarding the first user from a database not included in the professional networking system. In step 142, the first user account information is updated when the first user data read from the database not included in the professional networking system is different from the first user account information stored in the professional networking system.

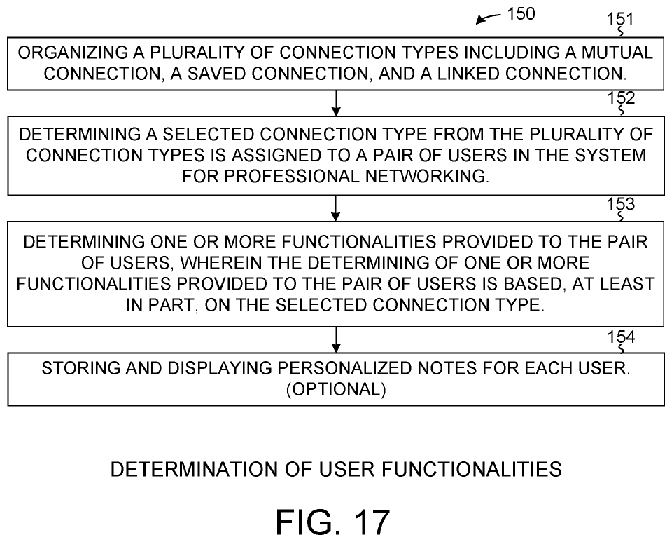

FIG. 17 a flowchart 150 diagram reciting the steps of determining one or more functionalities provided to a pair of users within the professional networking system. In step 151, a plurality of connection types is organized. The plurality of connection types includes a saved connection, a mutual connection, and a link connection. In step 152, a selected connection type from the plurality of connection types is determined and assigned to a pair of users in the system for professional networking. In step 153, one or more functionalities provided to the pair of users is determined. The determining of the one or more functionalities provided to the pair of users is based, at least in part, on the selected connection type. In step 154, personalized notes for each user are stored and displayed (optional).

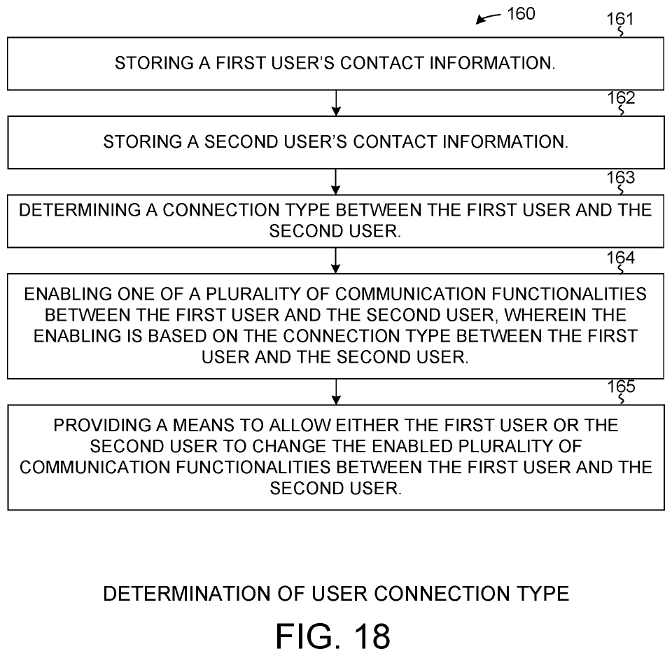

FIG. 18 is a flowchart 160 diagram reciting the steps for determining a connection type between a first and second user within the professional networking system. In step 161, a first user's contact information is stored. In step 162, a second user's contact information is stored. In step 163, a connection type between the first user and the second user is determined. In step 164, one of a plurality of communication functionalities between the first user and the second user is enabled. The enabling is based on the connection type between the first user and the second user. In step 165, a means to allow either the first user or the second user to change the enabled plurality of communication functionalities between the first user and the second user is provided.

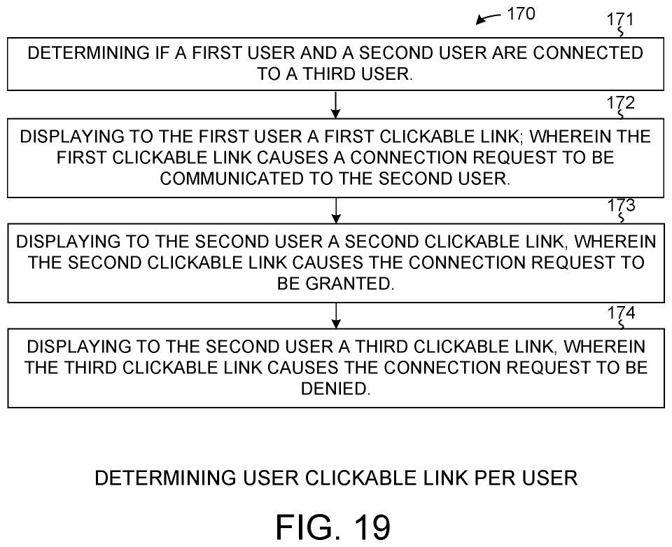

FIG. 19 is a flowchart 170 diagram for setting the steps for determining a type of clickable link to be displayed for each user within the professional networking system. In step 171, it is determined if a first user and a second user are connected to a third user. In step 172, the first clickable link causes a connection request to be communicated to the second user. In step 173, a second clickable link is displayed to the second user. The second clickable link causes the connection request to be granted. In step 174, a third clickable link is displayed to the second user. The third clickable link causes the connection request to be denied.

Although certain specific embodiments are described above for instructional purposes, the teachings of this patent document have general applicability and are not limited to the specific embodiments described above. Accordingly, various modifications, adaptations, and combinations of various features of the described embodiments can be practiced without departing from the scope of the invention as set forth in the claims.

1. A system for professional networking, comprising:
at least one processor;
at least one computer readable storage medium;
a plurality of connection types including a mutual connection, a saved connection, and a linked connection;
program code executable on the at least one processor and stored on the at least one computer readable storage medium, for:
(a) determining a selected connection type from the plurality of connection types is assigned to a pair of users in the system for professional networking; and
(b) determining one or more functionalities provided to the pair of users, wherein the determining of (b) is based, at least in part, on the selected connection type.

2. The system for professional networking of claim 1, wherein a link is created when a first user requests to link and a second user agrees to the request to be linked, and wherein the link between the first user and the second user enables an advanced communication feature.

3. The system for professional networking of claim 2, wherein the advanced communication feature is a direct messaging capability, a create group channel capability, or an invite other users to group channel capability.

4. The system for professional networking of claim 3, wherein the group channel is a multi-user chat group.

5. The system for professional networking of claim 2, wherein the advanced communication feature is not enabled for the saved connection.

6. The system for professional networking of claim 2, wherein the advanced communication feature is not enabled for the mutual connection.

7. The system for professional networking of claim 1, wherein a mutual connection is created when a first user and a second user are both connected to a third user, and wherein the first user and the second user are not connected.

8. The system for professional networking of claim 1, wherein a saved connection is created when contact information is entered into a first user's public facing webpage.

9. The system for professional networking of claim 1, wherein the system is configured to display a user interface, and wherein the user interface includes a tile of a network connection, and wherein the tile includes a visual indicator as to the connection type of the network connection.

10. The system for professional networking of claim 9, wherein the tile of a network connection includes a request to link button that when selected causes a request to link with a user identified in the tile to be generated.

11. The system for professional networking of claim 8, wherein the first user's public facing webpage is provided by the system for professional networking.

12. The system for professional networking of claim 1, further comprising program code executable on the at least one processor and stored on the at least one computer readable storage medium, for:
(c) storing and displaying personalized notes for each user.

13. A system, comprising:
a plurality of connection types including a mutual connection, a saved connection, and a linked connection;
a first means for determining a selected connection type from the plurality of connection types is assigned to each pair of users in the system for professional networking; and
a second means for determining one or more functionalities provided to each user, wherein the determining of (b) is based, at least in part, on the selected connection type.

14. The system of claim 13, wherein the first means include:
at least one processor;
at least one computer readable storage medium; and
program code executable on the at least one processor and stored on the at least one computer readable storage medium for performing the first means.

15. The system of claim 13, wherein the second means include:
at least one processor;
at least one computer readable storage medium; and
program code executable on the at least one processor and stored on the at least one computer readable storage medium for performing the second means.

16. A method, comprising:
(a) storing a first user's contact information;
(b) storing a second user's contact information;
(c) determining a connection type between the first user and the second user;
(d) enabling one of a plurality of communication functionalities between the first user and the second user, wherein the enabling of (d) is based on the connection type between the first user and the second user; and
(e) providing a means to allow either the first user or the second user to change the enabled plurality of communication functionalities between the first user and the second user.

17. The method of claim 16, wherein the means includes a clickable link on a user interface, and wherein the user interface is displayed on a device.

18. A method, comprising:
(a) determining a first user and a second user are connected to a third user;
(b) displaying to the first user a first clickable link; wherein the first clickable link causes a connection request to be communicated to the second user;
(c) displaying to the second user a second clickable link, wherein the second clickable link causes the connection request to be granted; and
(d) displaying to the second user a third clickable link, wherein the third clickable link causes the connection request to be denied.

19. The method of claim 18, wherein the first clickable link is not displayed to the first user if the first user is not connected to the third user.

20. The method of claim 18, wherein the first clickable link is displayed on a first device, and wherein the second clickable link is displayed on a second device.

21-28. (canceled)
